(19) United States
(12) Patent Application Publication
(10) Pub. No.: US 2009/0177493 A1
(43) Pub. Date: Jul. 9, 2009

(54) METHOD AND SYSTEM FOR PROVIDING CLINICAL DECISION SUPPORT

(75) Inventor: Vani Narayan, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/969,674

(22) Filed: Jan. 4, 2008

(51) Int. Cl. G06Q 50/00

(52) U.S. Cl. 705/3

(57) ABSTRACT

A method and system for providing medical decision support is disclosed herein. The method comprises: accessing a record pertaining to a patient stored with different patient parameters, including patient status and linking various patient parameters based on their relation. A change in at least one patient parameter is detected and the corresponding related parameters are identified. The related patient parameter may be displayed to a clinician for assisting him in providing clinical decisions or for seeking his feedback on updating the related patient parameter in the record. The record is further updated with the detected change in patient parameter and corresponding changes in the related patient parameter. In an embodiment, the record is an electronic medical record.

### FIELD OF THE INVENTION

This invention relates generally to clinical workflows, and more particularly to, a method and system for providing clinical decision support.

### BACKGROUND OF THE INVENTION

In a clinical workflow, different patient parameters need to be recorded and tracked in real time. For providing better patient care it is very essential to maintain a record with different patient parameters such as details of patient status or patient's medical conditions and the corresponding medication information including medications taken by the patient, treatment plan corresponding to each medical condition etc. Once these patient parameters are recorded, it is essential to update the record upon detection of a change in at least one patient parameter. For example, if the patient status changes, corresponding medication information needs to be updated in the record and the patient should be informed accordingly.

In the current scenario a patient record is maintained with various patient status parameters and corresponding medications. A clinician or the caretaker monitors the patient and records the patient status. The clinician may himself or request an operator to update the record with the identified patient status. Simultaneously the clinician or operator has to update the medications associated with the changed patient status. This information is conveyed to patient. However, in certain instances the clinician or operator might forget to update the record or inactivate the corresponding medication or might forget to inform the patient about the changes in the medication.

In an example of an electronic medical record (EMR), the electronic medical record is stored with patient status, indicting patient's medical conditions and corresponding medications taken by the patient. Once the patient status changes, a clinician has to manually go the particular field indicating the patient status and update the same. Subsequently he needs to update the corresponding medication as well. Many times the clinician may forget about the medications active pertaining to a patient problem. Hence it will be beneficial to remind him about the active medications as and when a patient status changes and this might help him in taking an appropriate clinical decision.

Thus a clinical workflow that involves recording patient parameters in real time is subject to errors as the clinician or caretaker may forget to update the records. Since the workflow essentially depends upon the efficiency of recording and updating the patient parameters in a database, it will be beneficial to limit the human intervention in maintaining the database to minimal.

Thus there exists a need to provide a method and system for providing decision support in a clinical environment and also for automatically maintaining a patient database.

### SUMMARY OF THE INVENTION

The above-mentioned shortcomings, disadvantages and problems are addressed herein which will be understood by reading and understanding the following specification.

One embodiment the present invention provides a computer implemented a medical decision support method. The method comprises the following steps: accessing a record pertaining to a patient stored with different patient parameters, including patient status and corresponding medications; linking various patient parameters based on their relation; identifying related patient parameters upon detecting change in a patient parameter; and updating the record with the changed patient parameter and the patient parameters related to the changed patient parameter.

In another embodiment, a method of maintaining an electronic medical record is provided. The method comprises: recording a first parameter and a second parameter in an electronic medical record, the first parameter and the second parameter are configured to be at least a patient status and corresponding medications for a patient; mapping relation between the first parameter and the second parameter; updating the electronic medical record upon detection of change in the first parameter; identifying the second parameter related to the changed first parameter using the mapping; soliciting a user feedback on updating the identified second parameter; and updating the electronic medical record with the identified second parameter in accordance with the user feedback.

In yet another embodiment, an automated medical decision support system is disclosed. The system comprises: a database stored with various patient parameters including patient status and corresponding medication for a patient; a detector configured to detect at least patient status and medication information; and a processor operably connecting the detector to the database, configured to update the database upon detecting a change in a patient parameter, wherein the processor is further configured to update the database with corresponding changes in other patient parameters related to the changed patient parameter.

In yet another embodiment, a computer implemented patient database maintenance system is provided. The system comprises: an electronic medical record stored with various problems of a patient and corresponding medication information; a data map linking the patient problems with the corresponding medication information; and an interface provided in association with the electronic medical record configured to update the electronic medical record with an identified change in state of problem, and to subsequently update the corresponding medication identified using the data map.

In yet another embodiment, the invention provides a computer-readable medium having one or more computer readable media for updating an electronic medical record. The medium comprises: a routine for mapping various patient parameters based on their relation, the patient parameter is configured to include at least patient status and corresponding medications; a routine for identifying the related patient parameters upon detecting a change in a patient parameter; and a routine for updating a database with the changed patient parameter and the patient parameters related to the changed patient parameter.

Various other features, objects, and advantages of the invention will be made apparent to those skilled in the art from the accompanying drawings and detailed description thereof.

### BRIEF DESCRIPTION OF THE DRAWINGS

FIG. 1 is a flowchart illustrating a clinical decision support method as described in an embodiment of the invention;

FIG. 2 is a flowchart illustrating a method of maintaining an electronic medical record as described in an embodiment of the invention;

FIG. 3 is a block diagram of an automated clinical decision support system as described in an embodiment of the invention;

FIG. 4 is a block diagram of a patient database maintenance system as described in an embodiment of the invention;

FIG. 5A to FIG. 5E show a diagrammatic representation of the method of updating electronic medical record as described in an embodiment of the invention; and

FIG. 6 is flowchart illustrating the steps involved in updating an electronic medical record upon detection of change in a patient parameter as described in an embodiment of the invention;

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments, a computer implemented method and system for clinical decision support is disclosed. The method or system links various patient parameters based on their relation and upon changing one patient parameter, the system displays the patient parameters related to the changed patient parameter to a clinician. This helps the clinician in making clinical decisions. In an example, the patient status reflecting the problems of a patient is linked with corresponding medications and upon changing the state of a problem, the clinician is provided with the corresponding medications that need to be changed in accordance with the changes in the state of the patient problem. In an embodiment, change in a patient parameter and corresponding changes in the related parameters are done automatically.

In an exemplary embodiment of an electronic medical record, whenever the clinician changes the state of problem of a patient, the corresponding changes are made with the medications stored in the electronic medical record. This could be done automatically or based on the opinion of a clinician.

In an embodiment the invention provides a method and system for maintaining an electronic medical record. The electronic medical record is stored with patient status along with corresponding medications. A map is created linking the patient status with the medication such that a change in one parameter will automatically update the other related parameters in the electronic medical record. In an embodiment the updation can be done based on a clinician's feedback.

In an embodiment, a fully automated database maintenance system is provided. The system is configured to automatically identify and change related parameters upon changing a particular parameter. In an example of a medical database, as and when a patient status is changed corresponding medications are identified and updated in the medical database. This could be done automatically or based on a clinician's opinion. The system can be configured to convey the changes in real time to the patient.

In an embodiment an improved patient care workflow is suggested. The workflow includes linking various patient parameters based on their relation and updating the related patient parameters automatically upon detecting a change in one patient parameter.

The term “parameter” referred in the specification need not refer to one parameter, but includes a list of parameters unless otherwise specified. Similarly the term “medication” or “medication information” refers to the medicines taken by a patient for a state of problem, his treatment plan, diagnostic plans, dietary requirements, periodical check ups etc. Also the expression “change” might include one or more changes occurring to the patient parameter in real time.

Though the example illustrated in the specification is limited to mapping of patient status and corresponding medication, the application of the invention need not be limited to this. This invention could be applicable to the various mutually related parameter recorded in an electronic medical record. For example, the bill payment in a medical facility may be linked with discharge summary of the patient.

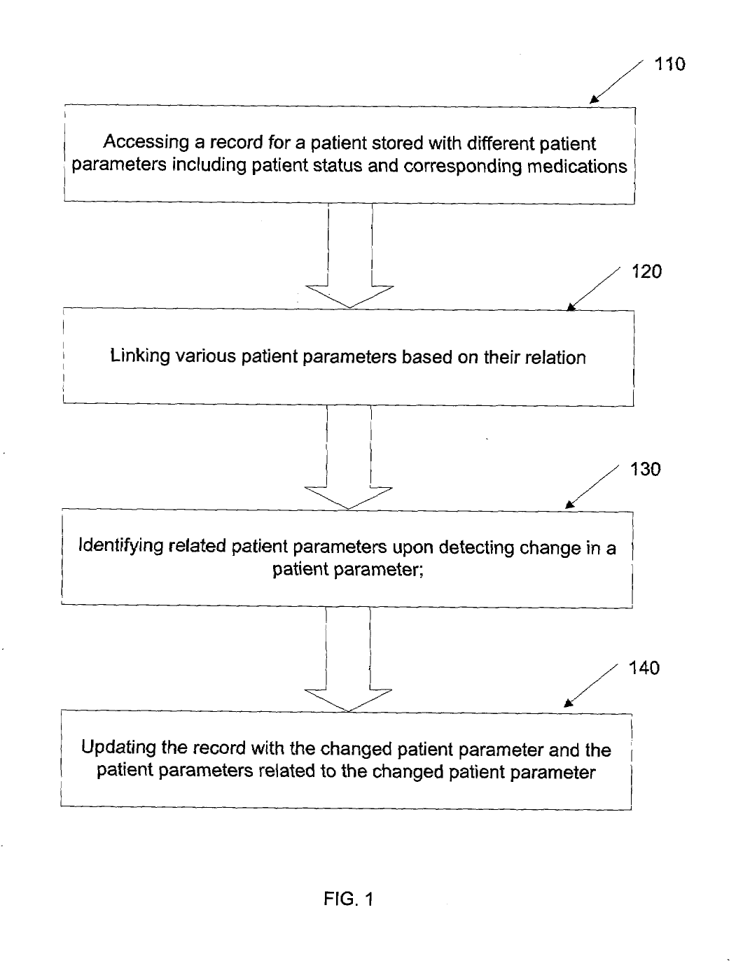

FIG. 1 is a flowchart illustrating a clinical decision support method as described in an embodiment of the invention. At step 110, a record stored with different patient parameters corresponding to a patient is accessed. The record may be accessed from a database, electronic files in different formats or might be an electronic medical record stored in any form of memory or in any database. In an embodiment, the patient parameter includes patient status and patient medication information. The patient status may reflect the state of problem of the patient and medication information may include the corresponding medications taken by the patient for the particular state of problem or the treatment or diagnostic plan. A record is maintained for each patient and separate records can be maintained for different patients. At step 120, various patient parameters are linked based on their relation. In an example, a link is generated by mapping the patient status and related medications. The mapping need not be a one to one mapping. For example different medications may relate to a single patient status. At step 130, related patient parameters are identified upon detecting a change in a patient parameter. In an embodiment, a patient monitor can automatically monitor the patient parameter and may detect the changes in the patient parameter. Alternately a clinician or caretaker may examine the patient and may detect the patient parameter. Also in case of self-medication, the patient himself may detect the changes in the patient parameter. In an example, the change in patient parameter may be the change in the state of problem of a patient. This step includes identifying the patient parameters related to the changed patient parameter. The related patient parameters may be found using the link generated based on the relation between various patient status parameters. The step may include identifying the changes that need to be incorporated in the related patient parameter corresponding to the detected patient parameter. The step may further include providing an indication about the identified related parameters to the clinician and this might assist him in taking clinical decisions. At step 140, the record is updated with the changes in the patient parameter. In different embodiments the patient himself, the clinician or an operator or caretaker may manually update the detected changes in the patient parameter. In alternative embodiments an automated patient monitor may automatically update the record with the detected change in the patient parameter. Once the detected change in the patient parameter is updated, other patient parameters related to the changed patient parameter are also subsequently updated. However the related parameters can be updated in accordance with a clinician or caretaker's instructions. In an example, if the patient status is changed, the corresponding medications may be updated. Once the patient status is changed, an alert may be provided to the clinician indicating the related medications and may seek his opinion in updating the medication.

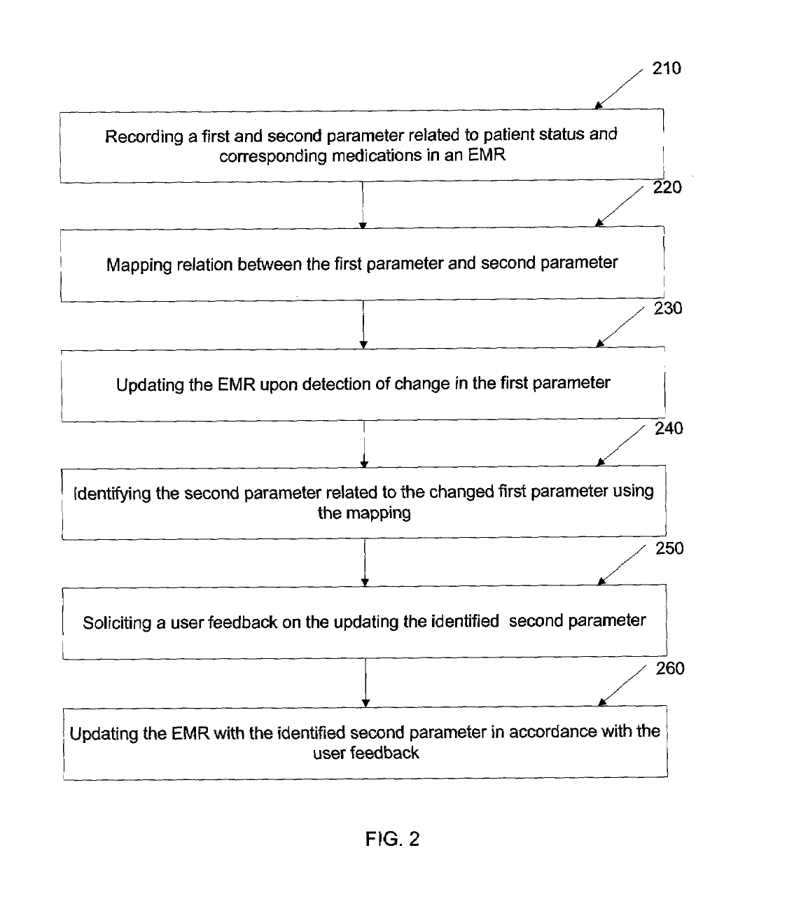

FIG. 2 is a flowchart illustrating a method of maintaining an electronic medical record as described in an embodiment of the invention. Electronic medical records are very popular as it eliminates the paper works involved in maintaining details of a patient. In electronic medical record, various patient statuses reflecting various problems of a patient are stored corresponding to each patient. It is also stored with medications or treatment plan corresponding to the patient problem. It is very essential to keep the electronic medical record updated. At step 210, different patient parameters are stored in the electronic medical record. In an example a first parameter and a second parameter are recorded, the first and second parameter may configured to be at least a patient status and corresponding medications for a patient. At step 220, the first parameter and the second parameter are linked or mapped based on their relation. The mapping among the first parameter and the second parameter need not be one to one mapping. For example, corresponding to patient status there could be different medications and alternately a single medication may take care of two patient problems indicated as two different patient statuses. The mapping may also need to be redefined in real time based on the changes in the patient parameters, time etc. At step 230, the electronic medical record is updated upon detecting a change in the first parameter. This could be achieved by automatically updating the electronic medical record upon detecting a change in the first parameter by a patient monitor. Alternately a clinician may detect the change in the first parameter and may update the electronic medical record manually or the clinician may delegate an operator who may update the electronic medical record with the detected change in the first parameter. At step 240, the second parameter related to the first parameter is identified. This could be done with the help of the mapping defined between first and second parameter. At step 250, a user feedback is sought on updating the second parameter with the electronic medical record. The feedback may be solicited from the operator or the clinician who updates the electronic medical record. The step further includes identifying the relation between the first parameter and the second parameter. Once the relation is identified from mapping defined between the first parameter and the second parameter, the clinician may be provided with an indication about the same. For example, if the patient status is changed, the medications associated with the patient status are identified and is made available to the attention of the clinician. The clinician may be queried about the updation of the second parameter in the electronic medical record. At step 260, the second parameter may be updated in the electronic medical record based on the user's feedback. For example the clinician may be asked whether the system can update the second parameter automatically and if the clinician agrees, corresponding medication can be updated in the electronic medical record. The step may further include updating the patient about the changes the first and second parameter.

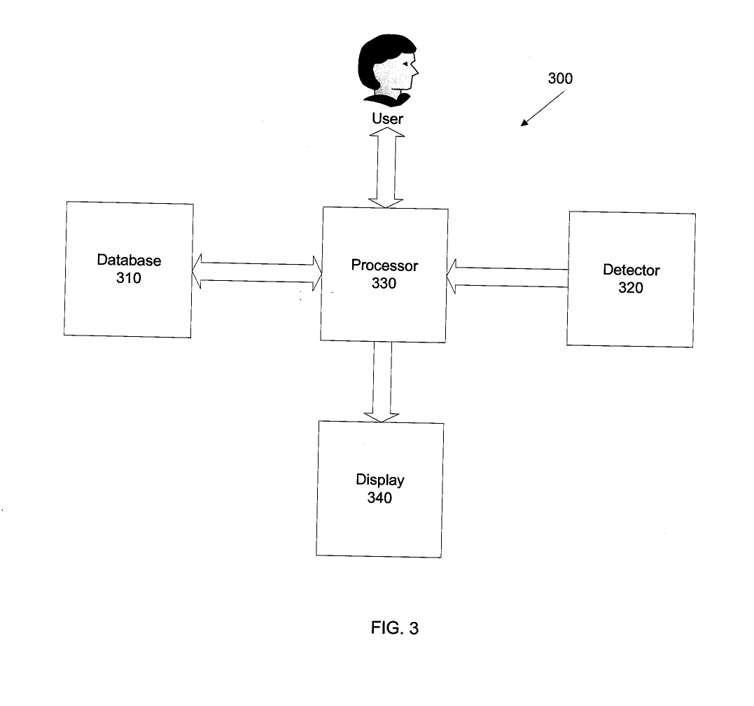

FIG. 3 is a block diagram of an automated medical decision support system 300 as described in an embodiment of the invention. The system 300 includes a database 310 stored with different patient parameters. The patient parameter might include patient status and corresponding medications. The database 310 may be an integral part of the system 300 such as the records stored in the system memory. However the database 310 may be accessed to the system 300 for providing medical decision support. For example the database 310 may be located at a remote location or in a server and could be accessed whenever required. The database 310 may also be provided in the form of readable memory devices, such as compact discs, pen drives etc. The system 300 further includes a detector 320 configured to detect a change in at least one image processing parameter. For example, the detector 320 may detect a change in the patient status or the corresponding medications. This could be detected manually by a clinician or a caretaker or automatically by a patient monitor. The patient monitor may detect various patient status including blood pressure, ECG, temperature etc. The detector 320 may detect the changes in patient parameter in real time or in a predefined interval. The detected changes in the patient parameters need to be updated in the database 310. The system 300 includes a processor 330 for updating the detected patient parameter to the database 310. The processor 330 is configured to generate a data map defining relation between various patient parameters stored in the database 310. The processor 330 identifies the patient parameters related to each other and their relation and links the related patient parameters. The processor 330 may be any processor that capable of to be used with a computer implemented system. The processor 330 updates the database 310 with the changes detected by the detector 310 and further with the help of the data map generated, the corresponding related patient parameters are identified and are updated in the database 310 automatically. For example, if the detector 320 detects a change in the patient status, the processor 330 updates the patient status in the database 310 and identifies the patient parameters related to the changed patient status and updates the same in the database 310. In an embodiment, a user feedback may be obtained for updating the related patient parameters in the database 310. The processor 330 displays the identified related parameter in a display 340 and a visual interface is provided seeking clinician's opinion about updating the related parameters. The processor 330 may provide the response option through a visual user interface and the clinician may select one option provided. In an embodiment, the database 310 may be an electronic medical record. The system 300 may further display the updated database in the display 340. The processor 330 may display the related patient parameters through the display 340, to a clinician for assisting him in taking clinical decisions. However the processor 330 may automatically update the database 310 with out any human intervention.

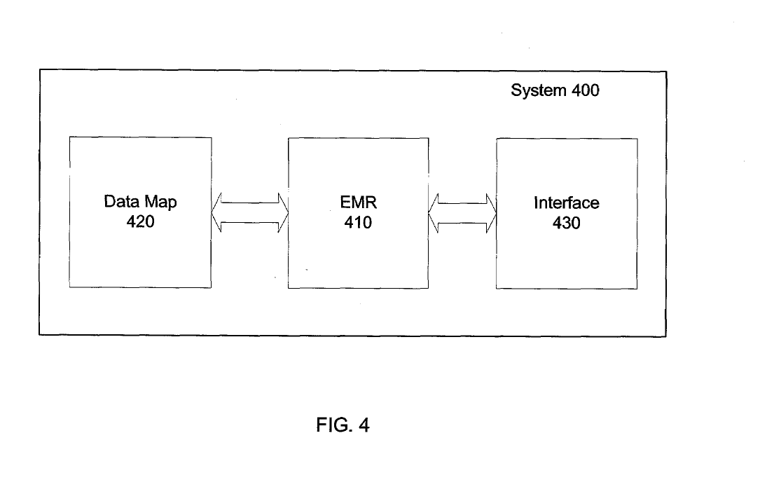

FIG. 4 is a block diagram of a patient database maintenance system as described in an embodiment of the invention. In an embodiment a system 400 for maintaining an electronic medical record 410 is described. The electronic medical record 410 is stored with different patient information along with various patient parameters. In an example, the electronic medical record 410 is stored with different problems of a patient and corresponding medication taken by the patient. The medication may include various medicines taken by the patient, the treatment plan, diagnostic requirements etc. In an embodiment a data map 420 defining relation between the problems of the patient and the medication, is provided in association with the electronic medical record. The data map 420 links the problems of a patient with the corresponding medications. The mapping need not be one to one mapping. For example, with respect to a patient problem, the patient may be taking more than one medication and while defining the date map, all the medications need to be linked to the corresponding patient problem. Similarly, the patient may take same medication for two different problems and accordingly when the medication changes, the other affected state of problems also need to be updated. The system 400 is further provided with an interface 430 for updating the electronic medical record 410. The interface 430 could be a software interface such a program to update a database or could be a combination of software and hardware interfaces such as a user interface including a joystick, light pen mouse etc. The interface 430 is configured to receive an indication about a change in the state of problems of the patient and accordingly updates the state of problems of the patient recorded in the electronic medical record 410. Further the interface 430 identifies the related medications using the data map 420 and updates the same in the electronic medical record 410. In an embodiment, the interface 430 is configured to interact with the clinician for obtaining user feedback on the display of related medication. Also the system 400 may be configured to display the electronic medical record with updated patient status and medication.

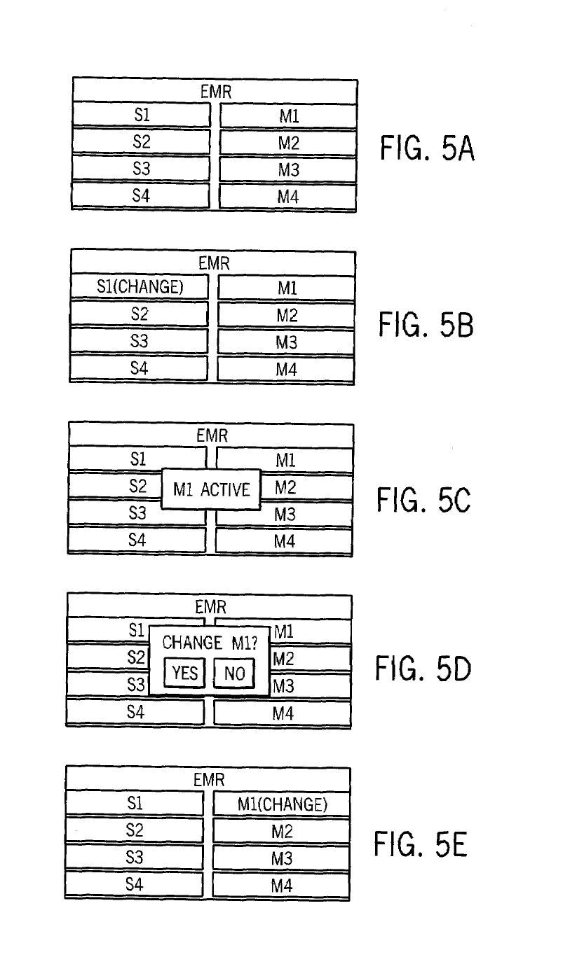

FIG. 5A to FIG. 5E show a diagrammatic representation of the method of updating electronic medical record as described in an embodiment of the invention. FIG. 5A shows a diagrammatic representation of electronic medical record stored with different patient status S1 to Sn and corresponding medications M1 to Mn. This is accessible to a clinician as and when required and is visually indicated to the user through a display. A mapping is defined based on the relation between various patient status and their corresponding medications.

The patient parameters recorded in the electronic medical record may change in real time and the electronic medical record needs to be updated with the corresponding changes. In an example, the patient status S1 recorded in the electronic medical record may be changed in real time. This could be updated automatically or by a clinician in the electronic medical record, as shown in FIG. 5B.

Once the patient status S1 is updated in the electronic medical record, corresponding related medications are identified. This could be achieved using the mapping defined relating the various patient statuses and the corresponding medications. In an example, the corresponding medication M1 is identified and this information is provided to a clinician or to the operator. This will help the clinician in his decision-making. This is illustrated in FIG. 5C.

Further the clinician is provided with an opportunity to express his opinion about updating the medications. For example, the clinician may be provided with a question asking whether M1 needs to be changed. Different response options could also be provided along with the query and the clinician may express his opinion by selecting the options provided. The options could be provided in the form of a user selectable buttons, displayed on the display. This step is illustrated in FIG. 5D.

Once the clinician provides his feedback, the electronic medical record is updated accordingly. In an example, if the clinician agrees to update the corresponding medication M1 with respect to the changes in the patient status S1, the electronic medical record is updated accordingly, as shown in FIG. 5E.

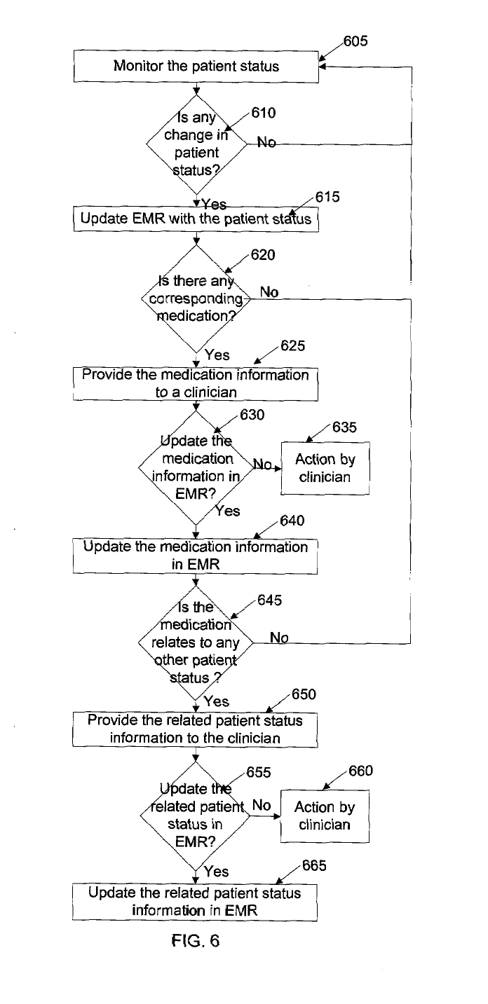

FIG. 6 is flowchart illustrating the steps involved in updating an electronic medical record as described in an embodiment of the invention. At step 605, the patient status reflecting the state of problem of a patient is monitored. This can be done manually by a clinician or automatically by a patient monitor. The patient status may be checked continuously or in a predefined interval. At step 610, a check is made to detect a change in patient status. If no change is detected the patient status will continued to be monitored as at step 605. If a change in patient status is detected the electronic medical record is updated with the patient status as at step 615. At step 620 a check is made to determine whether any corresponding medications related to the changed patient status exists in the electronic medical record. If no corresponding medication is identified the patient status will continued to be monitored as at step 605. Upon identifying corresponding medication relating to the changed patient status, it is indicated to a clinician as at step 625. This will help the clinician in taking clinical decisions. At step 630, the clinician being enquired about updating the corresponding medication information in the electronic medical record. If the clinician agrees, the medication information is updated in the electronic medical record as at step 640 and if not, the medication information is not updated and the clinician may take any appropriate action as at step 635. Upon updating the medication information, a check is made at step 645 to verify whether the medication relates to any other patient status. For example same medication may be taken for different patient problems indicated by various patient status. If yes, the related patient status is provided to a clinician as at step 650 and if not, continue monitoring the patient status as at step 605. At step 655, the clinician is enquired about updating the related patient status and if the clinician agrees, the related patient status is updated in the electronic medical record as shown at step 665 and if not appropriate action can be taken by the clinician as at step 660. However this is one example of a clinical workflow. Similarly different workflows may de defined based on the relation between various patient parameters.

In an embodiment a computer-readable medium having on one or more computer readable media for updating an electronic medical record is provided. The method comprises: routine for mapping relation between different patient parameters including patient status and corresponding medications; a routine for identifying the related patient parameter upon detecting a change in a patient parameter; and a routine for updating a database in real time with the changed patient parameter and is related patient parameter. In an embodiment the computer readable medium may further comprise a routine for soliciting a user feedback for updating the patient parameters related to the changed patient parameter.

Some of the advantages of the invention include linking various patient parameters based on their relation and this could be used in assisting a clinician in providing clinical decision. Also the invention is used to update an electronic medical record. The electronic medical record is either updated manually or updated with the help of a clinician. This will ensure that when a patient parameter recorded in the electronic medical record changes the related parameters are also updated in the electronic medical record. This simplifies the job of clinician and also increases the efficiency of clinical workflow.

The above-description of the embodiments of the methods and systems has the technical effect of updating electronic medical record automatically. The method and system will act as a decision support to the clinician as related changes in a parameter are automatically identified and displayed to a clinician.

Thus various embodiments of the invention describe a decision support method and system in clinical environment. Another aspect of the invention is to provide a system and method for maintaining a database.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. A computer implemented a medical decision support method comprising the steps of:
accessing a record pertaining to a patient stored with different patient parameters, including patient status and corresponding medications;
linking various patient parameters based on their relation;
identifying related patient parameters upon detecting change in a patient parameter; and
updating the record with the changed patient parameter and the patient parameters related to the changed patient parameter.

2. A method as claimed in claim 1, wherein the step of linking various patient parameters comprises: linking the patient status conveying at least one problem of a patient with medications relating to the patient problem.

3. A method as claimed in claim 1, wherein the step of identifying related patient parameters comprises: monitoring the patient parameter by a patient monitor or by a clinician for detecting a change in at least one patient parameter.

4. A method as claimed in claim 3, wherein the step of identifying related patient parameters comprises: identifying the changes in the related patient parameter corresponding to the detected patient parameter.

5. A method as claimed in claim 4, wherein the step of identifying related patient parameters further comprises: displaying the identified related patient parameters to a clinician for assisting in decision support.

6. A method as claimed in claim 1, wherein the step of updating the record comprises: updating the database automatically by a patient monitor or manually be a clinician.

7. A method as claimed in claim 6, wherein the step of updating the database further comprises: updating the identified related patient parameters in accordance with feedback of a clinician.

8. A method of maintaining an electronic medical record comprising:
recording a first parameter and a second parameter in an electronic medical record, the first parameter and the second parameter are configured to include at least a patient status and corresponding medications for a patient;
mapping relation between the first parameter and the second parameter;
updating the electronic medical record upon detection of change in the first parameter;
identifying the second parameter related to the changed first parameter using the mapping;
soliciting a user feedback on updating the identified second parameter; and
updating the electronic medical record with the identified second parameter in accordance with the user feedback.

9. A method as claimed in claim 8, wherein the step of identifying a change in the first parameter comprises: identifying a change in real time by a patient monitor or by a clinician.

10. A method as claimed in claim 8, wherein the step of updating the changes in the first parameter comprises: updating the first parameter in the electronic medical record automatically or manually.

11. A method as claimed in claim 8, wherein the step of soliciting user feedback comprises: displaying the identified second parameters for assisting a clinician in decision support.

12. A method as claimed in claim 8, wherein the method further comprises:
displaying the changed first parameter and the identified second parameter on a display.

13. A method as claimed in claim 8, wherein the method further comprises:
communicating the changes in the second parameter to the patient.

14. An automated medical decision support system comprising:
a database stored with various patient parameters including patient status and corresponding medication for a patient;
a detector configured to detect at least patient status and medication information; and
a processor operably connecting the detector to the database, configured to update the database upon detecting a change in a patient parameter, wherein the processor is further configured to update the database with corresponding changes in other patient parameters related to the changed patient parameter.

15. A system as claimed in claim 14, wherein the detector includes a patient monitor.

16. A system as claimed in claim 14, wherein the database is an electronic medical record.

17. A system as claimed in claim 14, wherein the processor is configured to generate a map defining the relations between various patient parameters.

18. A system as claimed in claim 17, wherein the processor is further configured to identify the patient parameters related to the changed patient parameter.

19. A system as claimed in claim 14, the processor is further configured to interact with a clinician for soliciting feedback on updating the patient parameters in the database.

20. A system as claimed in claim 14, further comprises a display for displaying the updated patient parameters.

21. A computer implemented patient database maintenance system comprises:
an electronic medical record stored with various problems of a patient and corresponding medication information;
a data map, linking the problems of patient with the corresponding medication information; and
an interface provided in association with the electronic medical record configured to update the electronic medical record with an identified change in state of problem, and to subsequently update the corresponding medication using the data map.

22. A system as in claim 21, wherein the interface is further configured to update the electronic medical record with an identified change in medication, in updation of corresponding state of problem in the electronic medical record.

23. A system as in claim 22, wherein the interface is configured to seek a user feedback while updating the electronic medical record with patient problems and corresponding medication.

24. A computer-readable medium having one or more computer readable media for updating an electronic medical record comprising:
a routine for mapping various patient parameters based on their relation, the patient parameter is configured to include at least patient status and corresponding medications;
a routine for identifying the related patient parameters upon detecting a change in a patient parameter; and
a routine for updating a database with the changed patient parameter and the patient parameters related to the changed patient parameter.

25. A computer-readable medium as in claim 24, further comprises: a routine for soliciting a user feedback for updating the patient parameters related to the changed patient parameter.
